(19) United States
(12) Patent Application Publication
(10) Pub. No.: US 2026/0043912 A1
(43) Pub. Date: Feb. 12, 2026

(54) METHOD AND APPARATUS TO SUPPORT POSITIONING USING AMBIENT INTERNET OF THINGS DEVICES

(71) Applicant: Huawei Technologies Co., Ltd., Shenzhen (CN)

(72) Inventor: Ngoc Dung Dao, Ottawa (CA)

(21) Appl. No.: 19/361,627

(22) Filed: Oct. 17, 2025

Related U.S. Application Data
(63) Continuation of application No. PCT/CN2023/089328, filed on Apr. 19, 2023.

(51) Int. Cl. G01S 13/42

(52) U.S. Cl. CPC G01S 13/42

(57) ABSTRACT

A method and apparatus for location determination. A signal is broadcasted and then, in response to broadcasting this signal, a modulated signal resembling the broadcasted signal that was transmitted by an electronic device is received. Location information is extracted from the received modulated signal using an identifier of the electronic device. Then the extracted location information is used to determine the location.

### CROSS-REFERENCE TO RELATED APPLICATION

This application is a continuation of International Application No. PCT/CN2023/089328, filed on Apr. 19, 2023, the disclosure of which is hereby incorporated by reference in its entirety.

### TECHNICAL FIELD

This application generally pertains to the field of location determination, and in particular, to the determination of a location using ambient internet of things devices.

### BACKGROUND

Many vehicles rely on obtaining their current location for a number of different functions. Vehicles with varying levels of autonomous driving capabilities are referred to as autonomous vehicles and require accurate location information that can be obtained rapidly in order to control their position. The current primary method used by autonomous vehicles to determine their location is to obtain a location estimate using information received from satellites of global navigation satellite system (GNSS), such as the global positioning system (GPS) in the United States of America, Quasi-Zenith Satellite System (QZSS) in Japan, BeiDou in China, Galileo in the European Union and Global Navigation Satellite System (GLONASS) in Russia. However, there are variable uncertainties in the location precision from these satellite systems which are part of the intrinsic design of how these systems operate. While this systematic inaccuracy is acceptable in some situations, these location errors may be the source of larger issues in autonomous vehicles. It should also be understood that resolving a location from satellite signals may be difficult if not possible at all geographic locations, as weather conditions, geologic formations, and even modern buildings may create signal degradations and obstructions that impede the ability of a receiver to have sufficient satellites within a line of sight. For an autonomous vehicle that needs reliable, continuous and accurate location information, reliance upon a satellite-based system may not be sufficient.

Accordingly, there is a need for a system and method that at least partially addresses one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present disclosure is to provide a method and apparatus for location determination using ambient internet of things devices.

In accordance with an embodiment of the present disclosure, there is provided a method for determining a location. The method includes broadcasting a signal. The method further includes receiving a modulated signal, resembling the broadcasted signal transmitted by an electronic device. The location information is then extracted from the received modulated signal using an identifier of the electronic device and the location is determined in accordance with the extracted location information.

In accordance with an embodiment of the present disclosure, there is provided a method for providing location information for execution by an electronic device. The method includes receiving a signal and then modulating the information on to a signal resembling the received signal using the received signal. The method further includes transmitting the modulated signal resembling the received signal.

In accordance with an embodiment of the present disclosure, there is provided an apparatus for determining a location. The apparatus includes a transmitter for broadcasting a signal and a receiver for receiving a modulated signal resembling the broadcasted signal. The apparatus further includes a memory for storing machine executable instructions. When these instructions are executed by a processor, the apparatus is configured to extract information from the received modulated signal using an identifier of a device that modulated the received modulated signal. The instructions also instruct the processor to processes the extracted information to determine a location of the apparatus.

In accordance with an embodiment of the present disclosure, there is provided an apparatus used to determine a location. The apparatus includes a receiver for receiving a signal. The apparatus further includes a memory for storing machine executable instructions. When these instructions are read from the memory and executed by a processor, the apparatus is configured to add information to the received signal and shift the frequency of the received signal to resemble the received signal. The apparatus further includes a transmitter for transmitting the shifted signal resembling the received signal.

In accordance with an embodiment of the present disclosure, there is provided a method for execution by an ambient electronic device to communicate with a connected and autonomous vehicle and also a mobile network. The method includes receiving information from a node within a mobile network and receiving a signal from the connected and autonomous vehicle. The method further includes modulating the received information on a signal resembling the received signal. The method further includes transmitting, towards the connected and autonomous vehicle, the modulated signal resembling the received signal.

In accordance with an embodiment of the present disclosure, there is provided an apparatus comprising a processor, a memory, a transmitter and a receiver of an ambient electronic device that are used to communicate with a connected and autonomous vehicle and also a mobile network. The apparatus includes the receiver for receiving a first signal from the mobile network and a second signal from the connected and autonomous vehicle. The apparatus further includes the memory for storing machine executable instructions, which when executed by the processor causes the processor to extract configuration and non-configuration information from the received signal, modify the second signal by adding the non-configuration information to the second signal and shift the frequency of the modified signal to resemble the second signal. The apparatus further includes the transmitter transmitting the shifted signal resembling the second signal.

Embodiments have been described above in conjunction with aspects of the present disclosure upon which they can be implemented. Those skilled in the art will appreciate that embodiments may be implemented in conjunction with the aspect with which they are described but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

Further features and advantages of the present disclosure will become apparent from the following detailed description, taken in combination with the appended drawings, in which:

FIG. 1 illustrates a network architecture, in accordance with the present disclosure.

FIG. 2 illustrates a detailed network architecture, according to an embodiment of the present disclosure.

FIG. 3 illustrates an alternate network architecture model, according to an embodiment of the present disclosure.

FIG. 4 illustrates a network architecture model including communication with two ambient electronic devices, according to an embodiment of the present disclosure.

FIG. 5 illustrates an alternative network architecture model including communication with two ambient electronic devices, according to an embodiment of the present disclosure.

FIG. 6 illustrates radio resource assignment for ambient electronic devices, in accordance with the present disclosure.

FIG. 7 illustrates ambient electronic device registration and configuration, according to an embodiment of the present disclosure.

FIG. 8 illustrates, in a schematic diagram, an electronic device in according with embodiments of the present disclosure.

It will be noted that throughout the appended drawings, like features are identified by like reference numerals.

### DETAILED DESCRIPTION OF THE ILLUSTRATIVE EMBODIMENTS

The term “Autonomous Things” (AuT) is used to refer to devices that can autonomously work on specific tasks without human interaction. AuTs can include robots, vehicles, drones, smart phone, smart home devices, autonomous software and any electronic device.

Self-navigating AuTs need to know their physical location so they can successfully self-navigate. As discussed above, this requirement for knowing the location may include a requirement for accuracy, rapid resolution of the locations, and robustness in the face of interference by weather or physical structures.

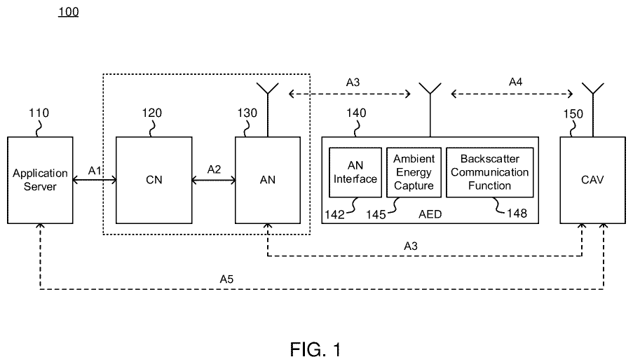

FIG. 1 is a block diagram illustrating a network for supporting an Ambient Electronic Device (AED) that can provide location information to an AuT such as an autonomous vehicle. The AED is connected to an application server. In the illustrated embodiment, this connection is through both an access network (such as a Radio Access Network) and a core network. The AED, subsequent to receipt of a signal from the AuT, transmits towards the AuT location information associated with the position of the of the AED. This location information can be used to provide location estimates, or in conjunction with the location of other AEDs can be used to determine a location estimate. Given a consistent turn around processing time, the AuT can determine a one way transmission time associated with any signal that includes a unique identifier that can be correlated to a transmission time from the AuT.

Architecture 100 shows an application server 110 connected, typically through a gateway, to the core network (CN) 120 of a wireless network, such as the fifth generation (5G) mobile network, or future mobile network generations. The CN 120 connects to an Access Network (AN) 130 of the wireless network. In some wireless networks, the CN 120 and AN 130 may be integrated in a single system. In some wireless systems such as WiFi systems, an access point (AP) may provide some or all functionalities of AN 130 and CN 120 that are described in the current disclosure. AN 130 communicates with AED 140 over a wireless link. AED 140 may include a set of subcomponents such as an AN interface 142, an ambient energy capture system 145 and a backscatter communications function 148. AED 140 may communicate with a connected autonomous vehicle (CAV) 150 over a wireless channel. This connection to the CAV 150 may be provided by the AN 130, as the CAV 150 may be in communication with the application server (AS) 110.

AED 140 as illustrated in FIG. 1 can act like a beacon. AEDs can include an AN interface 142, ambient energy capture 145 and backscatter communication function 148. The AN interface allows communications with AN 130 using a wireless interface as discussed above. Ambient energy capture subsystem 145 can provide AED 140 with the ability to augment battery power using captured ambient energy. In some embodiments, AED 140 may rely upon power captured by ambient energy capture subsystem 145 for a part or all of its power requirements. Backscatter communication function 148 of AED 140 can modulate a received signal, for example shift the frequency of a signal received from CAV 150 or AN 130. In some embodiments, ambient energy capture subsystem 145 can capture power from wind, solar, vibration, thermal energy, power extracted from a mobile radio signal in the public spectrum, power extracted from a radar signal and power extracted from the received radio signal. The captured ambient power may be stored in an energy storage device in the AED 140 such as a battery or a capacitor. Those skilled in the art will appreciate that if the ambient energy capture subsystem 145 captured energy from the radio signals that are used by backscatter communication function 148 and AN interface 142, these components may be integrated with each other.

In the illustrated embodiment, AED 140 transmits an encoded signal towards the AuT that can include location information of AED or a signal that can be mapped to the location information of AED, which may be supplemented by data received from the application server 110 over the AN 130. In a low power embodiment the transmission function is carried out by a Backscatter Communication Function 148.

Timing information can be derived from the transmitted signal from AED 140 or from other source such as the AN 130, or the CN 120, a GNSS system. As a non-limiting example, if the CAV transmits a radar signal toward the AED, the AED can backscatter the modulated radar signal and the CAV can estimate the arrival time of the received signal by comparing this arrival time with the time the radar signal was transmitted. As a result, the CAV can estimate the distance between the CAV and the AED. As another non-limiting example, if the CAV transmits a radar signal towards the AED, the AED can transmit the mobile radio signal received from the AN. This radio signal can include timing information. If the CAV is synchronized with the mobile network, the CAV can derive the duration between the time the AED transmits the mobile network signal and the time the CAV receives the AED signal.

Upon receipt of a signal from the AuT, the location information is overlaid onto a signal that is transmitted from the AED 140. This effectively encodes data onto a signal that is transmitted by backscatter communication function 148 or by the AN interface 140. The backscattered signal can be referred to as a transmitted signal that resembles the received signal communications function. In backscattering the received signal, AED 140 may shift the carrier frequency so that the backscattered signal is transmitted in a different frequency band than the AuT transmitted signal (the received signal) is received in. In other embodiments, the transmitted signal that resembles the received signal communications function can transmit the shifted signal to any CAV 150 or AN 130 capable of receiving the signal. In some embodiments, this frequency shift can be achieved by modulating the received signal.

In some embodiments, the AED can include an energy storage unit so that the transmitted signal's power can be more than the power of the received signal. This can be useful when the captured energy from the received signal is less than required. Those skilled in the art will appreciate that the transmitted signal power can be less than the received signal when necessary. The transmitted signal that resembles the received signal communication function can also modulate the received signal by some other methods such as frequency modulation, pulse width modulation, phase modulation, amplitude modulation, spread spectrum modulation, or any other methods, or any combination of these methods, before transmission in order to implement signal recovery, error detection and error correction at the CAV 150 or other receivers.

In some embodiments, the AED 140 may receive a signal from the CAV 150 and transmit a radio signal that carries location information by using the AN interface 142. The radio function of CAV 150 may be synchronized with the AN 130 and can receive the location information in the signal sent from AED 140.

In some embodiments, the AED 140 can include an energy storage (such as a battery store or a capacitor), captured ambient energy or other such power supply to supplement powering the operation and transmission functions of the AED 140.

AED 140 can be a simple device comprised of one or more antennas with multiple passive electronic devices or complex and comprise one or more antennas with multiple active devices and a microprocessor.

The transmitted signal that resembles the received signal communications function can also add information to the shifted (modulated) signal. In some embodiments, this signal may also be transmitted to CAV 150 or any wireless devices nearby. In some embodiments, this shifted (modulated) signal is known as a backscattered radio signal. This information can include security information, card number, verification information and the like.

As a non-limiting example, CAV 150 can be a self-navigating AuT with a wireless network interface to communicate with wireless networks. In some embodiments, the CAV 150 may be the AuT that transmitted the initial signal that started this process. In some embodiments, CAV 150 can transmit radar signals to AED 140. In other embodiments CAV 150 can transmit cellular signals, such as 4G/5G signal, to AED 140.

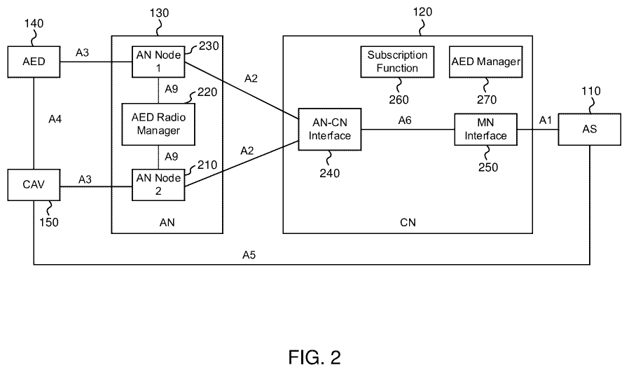

FIG. 2 illustrates an alternate configuration of the system illustrated by FIG. 1. FIG. 2 shows the CN 120 functions that can include a radio access network interface (AN-CN interface) 240, an application server (AS) interface (the mobile network (MN) interface) 250, a subscription management function 260 and an AED manager 270.

AED manager 270 can store AED device information in the subscription function and can also configure the network operation to support a group of AEDs. AED manager 270 can provide this configuration by sending a policy to the radio network to define the data rate used to communicate with AED 140 or the number of messages that can be transmitted to AED 140 over a specific period of time. AED manager 270 can also perform traffic management by providing quality of service (QoS) policies. Based on these policies, the AED radio manager 220 can assign the required number of radio resources needed to support AEDs.

The subscription function 260 can manage more than just subscription information. It can store and manage the information provided by AS 110. It can also manage network policy in terms of how to direct traffic from an AED 140 to the AS 110.

The subscription function 260 can manage subscription of CAV 150 if the CAV 150 supports an AN interface to connect with the wireless network. The AED manager 270 can manage the AED subscription, including parameters of devices connected to CN 120 via AN 130. These AED parameters can include device identification number, device type information, frequency bands AED 140 can work within, data rates supported by AED 140 and the like.

AN 130 can include AED radio manager 220 which can also manage radio access network interface parameters of AED 140. This AED radio manager 220 can be used to assign radio resources to a device requesting access to the mobile network. AN 130 can send configuration information to AED 140 so that AED 140 can communicate synchronously with AN 130. This synchronous communication can be implemented by allocating network resources, such as time slots, when AED 140 can communicate with AN 130. Communicating on specified network resources can result in a reduction of signal interference that would result if multiple AEDs communicate with AN 130 at the same network resources. More than one AEDs may be allocated the same network resources, such as the same time slots, the same frequency bands. In this case, the AN 130 may use some technologies to separate the signal transmitted to multiple AEDs or to decode signals received from multiple AEDs. AED 140 and a CAV 150 can also directly communicate with AS 110 to collect information, including traffic conditions, directly from AS 110 by using some interfaces that do not use the wireless network. AED 140 can also collect information from AS 110 indirectly via AN 130 and CN 120.

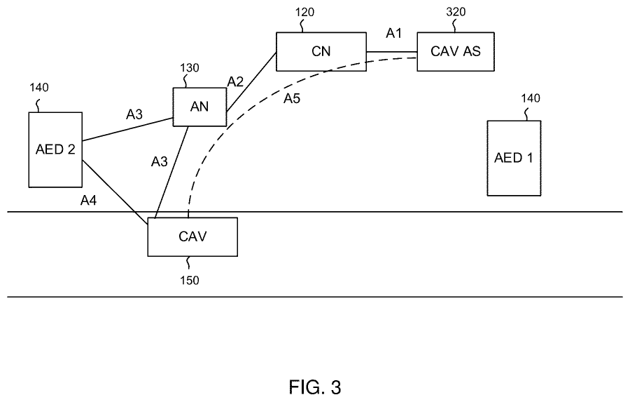

FIG. 3 illustrates an example of the signaling between an AED and elements within the network that registers the AED. The first time the AED registers with the network, it must submit a registration request message to CN 120 via AN 130. This registration request can include information such as a device identifier of the AED or other such account identifier and the capabilities of the AED as well as identification of radio parameters provided by the mobile network and used when transmitting towards the CAV. A person skilled in the art will appreciate that a CAV is also commonly referred to as an AuT. The subscription function (not shown in FIG. 3 but part of CN 120 as shown in FIG. 2) can verify that this submitted information belongs to a valid subscriber.

FIG. 3 also illustrates CAV 150, CAV application server (CAV AS) 320 and two AEDs 140. The CAV AS 320 can provide the AEDs 140 with information and this information can include one or more of weather, traffic and road condition information, and any other information so that the AEDs 140 can send this information to CAV 150 when CAV 150 communicates with the AEDs 140.

CAV 150 can broadcast a radio signal (or a radar signal in some embodiments), using a transmitter, to one or both AEDs 140. Upon receipt of this signal, each AED can in turn transmit a signal to CAV 150 that resembles the received signal from the CAV 150 or from the AN 130. CAV 150 in turn receives this signal resembling the signal the AED(s) received using its receiver.

To reduce interference, the signal transmitted by one of the AEDs can be transmitted in radio resources assigned by the wireless network. The assigned resource may be a time slot, a frequency, a transmit power level, a location, a direction, a code sequence, or any other method, or any combination of these methods, that is the same or different than the signal transmitted by the other AED. This signal is also received during this same or different assigned network resource as the signal transmitted by the other AED. If the same radio resource is assigned to more than one AED, the CAV 150 may use some signal detection methods to separate the signal transmitted from multiple AEDs.

This signal that resembles the signal that one of the AEDs received can be generated by the AEDs by modulating the signal received by the AEDs.

In some embodiments, AEDs can receive radio resource configuration data from AN 130 comprising radio resources that the AEDs may use to communicate with the CAV. For example, the radio frequency could be the radar frequency for backscattering the received radar signal from the CAV 150. The radio frequency could be the radio resources of the wireless network to backscatter the radio signal of the wireless network that conveys the location information to the CAV 150. The radio resource could be one or more timeslots and one or more resource blocks of OFDM data frame that the AED may use to transmit the location information to the CAV 150 over a radio spectrum.

Through a data channel, CAV 150 can receive information, such as a list or a map that includes the location of one or more AEDs within a specific region. This may be received through a wireless communication channel such as through the AN 130 that provides a connection to the CAV AS 320. In some embodiments, this location can be stored by the CAV and related to a specific AED identifier to allow the CAV to identify the location associated with the AED that transmits the location information signal.

In some embodiments, since CAV 150 can receive multiple signals from the AEDs, CAV 150 can identify the location associated with the multiple AEDs that transmitted these signals in the assigned radio resource. This identification of the location associated with an AED may be performed by identifying an AED identifier in the received transmission and/or by radio resource that the AED uses. Each AED transmits radio signal towards CAV 150 on its assigned radio resource. Each AED may transmit its location information in the radio signal towards CAV 150. The AED location information could be the AED location in the map, the AED ID, a data string that represents the AED, or any combination of this information.

CAV 150 can demodulate the received modulated signals and extract the location information. CAV 150 can use the information extracted from the signals received from AED 140 to estimate its location.

In some embodiments, this location information can comprise an identifier of the AED. In some embodiments, this location information can be obtained by detecting the presence of radio signal on the radio resource that is assigned to the AED. In some embodiments, the location information is obtained by decoding the received signal that carries the location of AED in the map.

In some embodiments, this map can be received by CAV 150 from a software application when CAV 150 enters a region such as an indoor parking garage, an indoor warehouse, and city streets with many high-rise buildings. The map can be provided by the CAV AS 320 or by a server of mobile network operator, which may be located in the CN 120 or in the AN 130. CAV 150 can use this map to estimate its location based on absolute, or relative, AED 140 location information provided by the map. CAV radio receiver (not shown) can estimate the location of CAV 150 by measuring the direction (e.g. angle of arrival and/or angle of departure) of the signal(s) received from AED 140 and also the measured distance between CAV 150 and AED 140. It should be appreciated that receiving location information from multiple AEDs reduces the error in the CAV 150 relative location estimation. For example, the CAV 150 may estimate its location from the estimated distances from the CAV 150 to multiple AEDs.

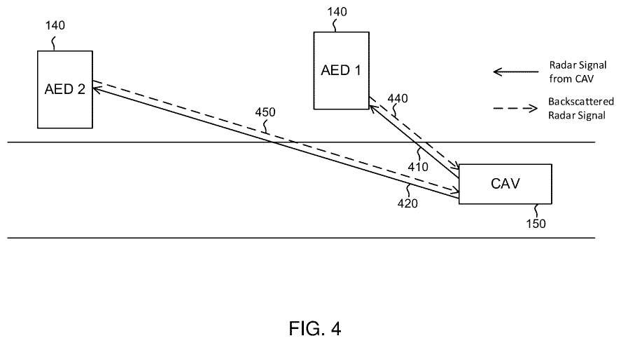

FIG. 4 illustrates an example of the signaling between CAV 150 and multiple AEDs. The AEDs backscatter the signal received from CAV 150/HWC

CAV 150 can send one or more radio signals 410 and 420 to one or both AEDs 140. The radio signals 410 and 420 may be the same radar signal transmitted to detect objects in the road and roadside. In the illustrated embodiment of FIG. 4, radio signal 410 is received at AED 1, and radio signal 420 is received at AED 2. Each AED receiving a signal, can then reply by encoding data into a signal resembling the received signal. The encoded data may include one or more of weather, traffic, road condition information, parking information, AED location information, and an identifier of the AED, or any other information. As such, AED 1 transmits signal 440 towards CAV 150, and AED 2 transmits signal 450 towards CAV 150. These signals 440 and 450 may be generated through a backscatter process, or through other processes that will be understood by those skilled in the art. Signal 440 resembles signal 410, but may be shifted in frequency or other such property. Similarly, signal 450 resembles signal 420. To reduce interference, the signal transmitted by one of the AEDs can be transmitted during a different time slot and/or transmitted at a frequency that is different than the signal transmitted by the other AED. These transmissions are thus effectively transmitted in defined time and frequency resource blocks so that the different signals do not interfere with each other during receipt by CAV 150. By detecting the presence of backscattered radar signal in some specific time shift or Doppler shift, CAV 150 can identify the AED ID that is associated with the radio resource. Furthermore, CAV 150 may identify the AED ID or location information by decoding the information carried in the backscattered radar signal. Using the decoded AED ID, decoded location information, or the radio resource parameter(s), or combination of these information, CAV 150 can find the location of AED in the map. CAV 150 can estimate its relative location compared to the location of AED, so CAV 150 can estimate its location in the map or its absolute location.

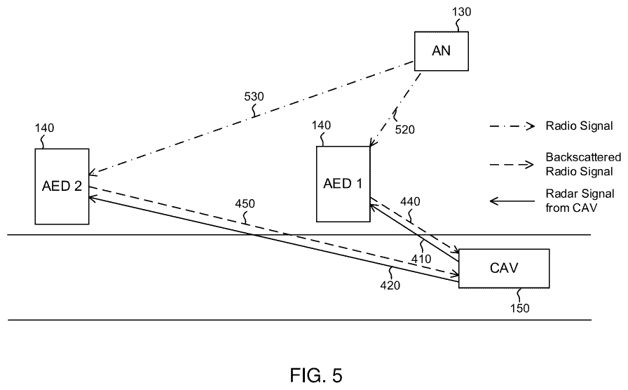

FIG. 5 illustrates CAV 150 communicating with both AEDs 140. As shown in FIG. 5, CAV 150 transmits signals 410 and 420 to AEDs 140. In some embodiments, this signal can be a radar signal. In some embodiments, this signal can be radio signal transmitted in a specific radio resources configured by the wireless network and known by AEDs.

AEDs 140 transmit signals 440 and 450 that resembles the signal received from AN 130 to CAV 150. Supplemental information can be included in signals 440 and 450 transmitted by AEDs 140 to CAV 150. This supplemental information can be non-configuration information extracted from the signals received by AEDs 140 and transmitted from radio base station AN 130. Supplemental information can include one or more of weather, traffic, road condition information, parking information, AED location information, and an identifier of the AED that transmitted signal 440 or 450, or any other information. AN 130 transmits this supplemental information to AEDs 140 via signals 520 and 530. Configuration information can be extracted from signals sent by AN 130 to AEDs 140. In some embodiments, receiving the signal 410 and 420 can trigger the AED 1 and 2, respectively, to transmit signals 440 and 450. The signals 440 and 450 can be backscattered signals of signals 520 and 530, respectively. The signals 440 and 450 can be a signal generated by the AED 1 and 2, respectively, independent of the signals 520 and 530.

In order for CAV 150 to detect signals 440 and 450 transmitted by multiple AEDs, where transmitted signals 440 and 450, AEDs 140 can be configured to use a radio resource when transmitting signals to CAV 150. The radio resource can be any combination of time slot, frequencies, frequency shift, Doppler shifts, encoding or code type, directions, spaces, polarizations, power levels or using any signal separation and modulation methods. The configured radio resources for AEDs 140 may be the same or different. If the configured radio resources for the AEDs 140 are the same, the CAV 150 may use some signal detection methods to separate and/or decode the signal 440 and 450. By detecting the presence of radio signal 440 and/or 450 in some radio resources, CAV 150 can identify which AED transmitted this signal and location of AED. Furthermore, CAV 150 may decode the received signal 440 and/or 150, which may carry location information, such as the AED ID or the location of AED in the map. By knowing which AED has transmitted a radio signal, CAV 150 can estimate its relative location to the AED and then derived its location in the map.

In some embodiments, as a non-limiting example, configuration information can be received by an AED over the radio network. A network function, such as AED Manager 270 or AED Radio Manager 220 illustrated in FIG. 2, or other such centralized entity can configure AEDs 140 to modulate the receive radar signal from CAV 150, for example adding Doppler shift D1 and D2 to the frequency of signals 410 and 420 received from the CAV 150 and transmitted as signals 440 and 450 to CAV 150. If CAV 150 transmits a radar signal with carrier frequency of F=77 GHz, the transmit carrier frequency of signals from AEDs 1 and 2 can be F+D1 GHz and F+D2 GHz, respectively.

In some embodiments, as a non-limiting example, AEDs 140 can be synchronized in time with a clock of AN 130 in order to support accurate location estimation by CAV 150. This synchronization can also allow AEDs 140 to be configured to transmit signals 440 and 450, that resemble signals 410 and 420 received from CAV 150, to be separated in time by a defined interval, such as 0.1 ms.

AN 130 can use orthogonal frequency division multiplexing (OFDM) for transmission in the radio access network, such as within 4G and 5G mobile networks.

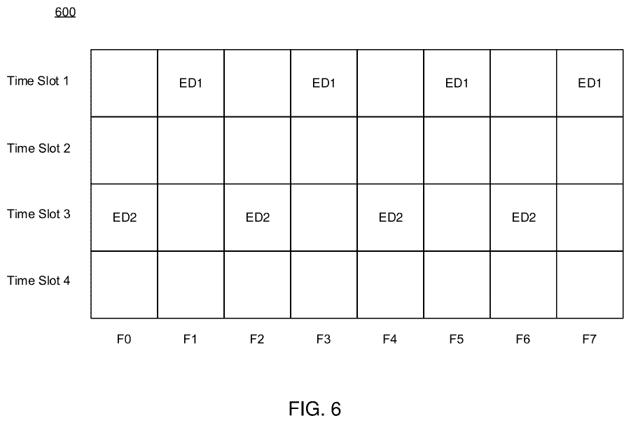

FIG. 6 illustrates resource blocks defined by time slots and subcarriers 600. These time slots and subcarriers can be assigned to AEDs 140 and applied to transmission of signals 440 and 450. These time slots and subcarriers can also be assigned to CAV 150 for transmission of signals 410 and 420.

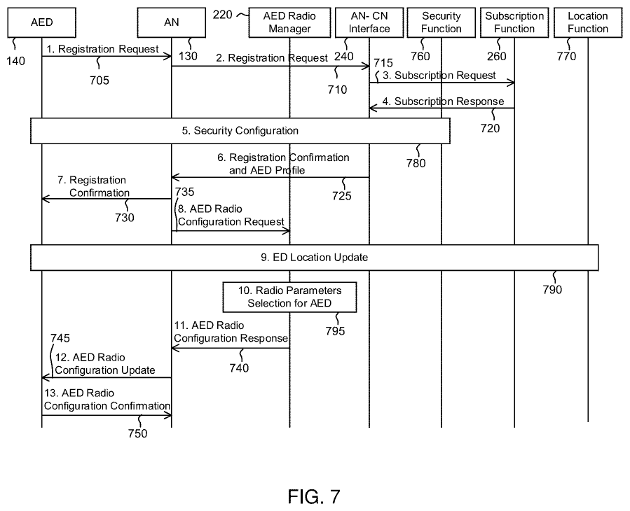

FIG. 7 is a call flow diagram illustrating an example of the AED registration and configuration processes on a mobile network.

At step 1, the AED 140 first sends a registration request message 705 to AN 130. This request can be transmitted over a control plane (CP) interface and the message 710 can contain one or more parameters of the AED. This request can also include an AED 140's identifier. AED 140 can provide its capability that can include one or more of the following parameters:
a. An indication of if AED 140 is equipped with a backscatter communication function (BCF) and its capability. This capability can, in some embodiments, be represented by a category number.
b. The maximum duration that the AED messages can be exchanged with the mobile network within a specific time period.
c. The maximum duration that AED 140 can be in an active state (max-active-time) and able to communicate with the mobile network.
d. The minimum time AED 140 must be in the inactive state. If the AED 140 is in the inactive state, some part or all of the transmitter and/or receiver of the AN interface may be turned off; the wireless network may not be able to communicate with the AED 140.
e. The energy source that AED 140 can use to support its operation and its charging time. These energy sources (ambient energy source) can include any combination of light, wind, a mobile radio signal (e.g. in the public spectrum), vibration, thermal energy and radar signal, and any other ambient energy sources.
f. The carrier frequency that AED 140's RU can use to transmit a signal that resembles the received signal.
g. The spectrum bandwidth around the operating frequency.
h. The method (backscatter modulation method) used by AED 140's BCF, for example, can include any combination of frequency modulation, amplitude modulation, phase modulation, orthogonal frequency division multiplexing, Doppler shift, time shift, and pulse width modulation, spectrum spreading. With time shift modulation, the AED 140 may transmit signal carrying the location information or any information at a specified delay after receiving the signal from CAV 150.
i. The energy storage capability: such as energy storage type (e.g. rechargeable battery, non-rechargeable battery, capacitor), energy storage capacity, such as battery capacity of AED 140.
j. The maximum message size (e.g. in bits or bytes) that can be sent from AED 140's BCF to other receivers.
k. The signal used to trigger the transmission of AED 140. Triggers can include any combination of a radar signal, mobile signal, and a message received from the mobile network.
l. The carrier frequency range(s) that AED 140 may use to transmit a signal that resembles the received signal.
m. The radio transmission method that the AED 140 may use to transmit the location information. For example, backscattering the received radar signal from the CAV 150, backscattering the received wireless signal from AN 130, such as 4G, 5G, 6G cellular signal. The AED 140 may also generate and transmit an independent wireless signal at the configured radio resources.

When the mobile network provides service to AS 110, the mobile network can allow AS 110 to provide AED information so that the mobile network can configure AED 140 correctly. AS 110 can provide the AED capability to the mobile network as follows:
n. AS 110 can send the AED capability provision message to AED manager 270. This message can be transferred via a mobile network interface, which as a non-limiting example can be a network exposure function (NEF) as in a 5G mobile network. This message can include one or more of the following parameters:
   i. One or more AED ID(s), which as a non-limiting example can be a general public subscription identifier (GPSI).
   ii. AED group ID to indicate to which group the AED belongs.
   iii. The location AED 140 can provide service or may operate. Non-limiting examples can include geographic location, civic address, cell ID of a RAN node, tracking area ID (TAI) of mobile network.
   iv. AED capability parameters.
   v. Data network (DN) to indicate the network that AED 140 can access. This can include the network of AS 110, the Internet, and operator network.
   vi. Network slice information. This can include the network slice that AED 140 can belong to or may access to connect with AS 110. The network slice information can also include one or more network slice selection assistance information(s) (NSSAI) and one or more single network slice selection assistance information(s) (S-NSSAI).
o. AED manager 270 can receive the AED capability provision message from AS 110 or from the mobile network interface. AED manager 270 can send received AED information to the subscription function to store the AED information. The AED information can include the any combination of AED capability parameters in the AED capability provision message. The subscription function can assign an internal group ID for mapping AED 140 to the AED group ID provided by AS 110. The subscription function can store the AED data in a storage function. Alternatively, AED manager 270 can send the information received from AS 110 to the storage function.
p. The subscription function (or storage function) can send AED manager 270 a response message to confirm the AED capability provision message described in step b has been received.
q. AED manager 270 can send a response message to the application function to confirm the receipt of the message in step a. This response message can be sent via the mobile network interface function.

At step 2 AN node 130 can forward request 705 to the AN-CN interface 240 as request 710. For example, the AN-CN interface can be an AMF (access and mobility management) in 5G mobile network.

At step 3, the AN-CN interface 240 can then send subscription request 715 to subscription function 260 in order to obtain the subscription information. This subscription information is provided as a subscription response. Subscription request 715 can include one or more of the parameters included in registration request 710.

Then, at step 4, once the subscription response is received, if AED 140 is authorized to use the mobile network, the subscription function can send subscription response 720 to the AN-CN interface function. This subscription response 720 can include one or more parameters including the one or more AED capability parameters, if the subscription function 260 has AED capability parameters of AED 140 and a mobility indication to indicate if AED 140 is fixed or mobile.

The AN-CN interface 240 can, at step 5, communicate 780 with security function 760 to exchange security information. This exchange can include the provision of encryption parameters to AED 140 to ensure that messages are protected by some encryption methods while being sent over the radio channel.

The AN-CN interface 240 at step 6 may send message 725 to AN node 130. Message 725 may comprise a registration confirmation message for the AED 140 and an AED profile message for the AN node 130.

At step 7 AN node 130 may receive message 725. The AN node 130 may store the AED profile in a local memory or a storage function. The AN node 130 may forward the registration confirmation message to AED 140 in message 730. Message 725 can include AED 140's profile, which can include one or more AED capability parameters as well as the encryption parameters and the capability information of AED 140. This capability information can include a description of AED 140's energy source. Knowing AED 140's energy source can be important information because if the energy source is a battery, this battery may provide sufficient power to enable a higher data rate or communication for a longer period of time. However, if AED 140's power source is an ambient energy source, the maximum data rate and communication time may be more limited. Also, if AED 140's energy source is ambient energy, the time required for AED 140 to acquire sufficient energy to wake up could result in AED 140 staying longer in inactive mode. As a non-limiting example, it may take AED 140 10 milliseconds to acquire enough energy for 1 milliseconds of communication.

AN 130 can then send AED 140's profile, as well as the AED ID, AED capability parameters, AN node ID and mobility indication to AED radio manager 220. This information is sent at step 8, via signal 735, so that the physical layer parameters of AED radio manager 220 can be configured and so that AED 140 can also be configured.

At step 9, AED radio manager 220 can perform procedure 790 to estimate the physical location of AED 140. This physical location can be represented by a two dimensional or three dimensional Cartesian coordinate. Alternatively, AED 140 can provide its relative location (such as one or more distances to nearby objects like radio AN 130) on a map or absolute location (such as indicated by latitude and longitude of AED) to AED radio manager 220. At this step, the location of AED 140 can be additionally updated by sending its location information that it can use to determine its absolute location (e.g. in a public map) or relative location (e.g. in a building, parking garage). AED 140 can use one or more methods to process the information to determine its location. These methods can include information that was manually mapped to a location or by using an automated method that can include using the up-link signal sent from the AED 140 to one or more radio receiver points of AN, or by using the down-link signal sent from one or more radio transmit points of AN.

At step 10, based on the location of AED 140, AED radio manager 220 can select radio configuration parameters 795 for AED 140. These parameters can include one or more of following parameters: Doppler shift, time shift the transmit power of the transmission, transmit time slot, subcarrier, resource block, phase shift, modulation signal, and location of AED 140. Doppler shift can be assigned to AED 140 if AED 140 can transmit a signal resembling the received signal, e.g. a received radar signal at a specified frequency or frequency range(s). Transmit power of the transmission of a signal that resembles the received signal indicates the maximum transmission power of the AED. The transmit time slot may be one or more time slots of OFDM frame as in 4G or 5G air interface, in which the transmit time of the AED is synchronized with the clock of the mobile network, or the clock of AN 130. It is also important when one or more time slots can be assigned to the AED. Subcarrier can be important if the AED can transmit OFDM signals because the AED can be assigned one or more specific subcarrier number, or one or more resource blocks, for transmission of signals. Phase shift can be assigned to an AED if the BCF uses phase shift modulation. It should also be appreciated that the location of AED 140 can be a two dimensional or three dimensional map location, or latitude and longitude of AED.

At step 11, AED radio manager 220 can send AED radio configuration response message 740 that include the AED radio configuration parameters. The message 740 may also include the time the AED radio configuration response message may be sent from AN 130 to AED 140. This message 740 can include one or more parameters assigned at step 10.

At step 12, AN 130 can send an AED radio configuration update message 745 to AED 140. This message 745 may include AED radio configuration parameters received at step 11.

At step 13, AED 140 can send an AED radio configuration confirmation message 750 to AN 130 in order to confirm that AED 140 has received radio configuration parameters. AED 140 may also specify the transmission parameter of the RU in message 750.

After registering with the mobile network, AED 140 can start exchanging messages with AS 110. AED 140 may send its location and the AED radio configuration parameters to AS 110. AS 110 can assign an application ID to AED 140 to identify the AED and also send the AED application ID (known as configuration information) to AED 140. AS 110 may update the two dimensional or three dimensional map to include the AED information. This information can include AED 140 location, the application ID of AED 140 and AED radio configuration parameters. These map updates can be then sent to other devices including one or more CAVs that have subscribed to the map. CAV 150 may obtain the AED radio transmission parameters in order to detect the signal transmitted from AED 140. These parameters can include carrier frequencies, time slots, subcarriers, signal modulation method, location information, and Doppler shift information.

The mobile network can also send AED 140 information to AS 110 using the following method. The first step is that AED radio manager 220 can send a message to CN 120's AED manager 270 in order to update AED 140 information. This message can include the AED ID, its location and its radio configuration parameters and can be transmitted using the AN-CN interface function, such as the AMF in 5G network. The next step is for AED manager 270 to store the received AED information in a storage function, such as unified data repository (UDR) in 5G network, that can be accessible by AED manager 270. Next, AED manager 270 can send to AS 110 the information received from AED radio manager 220 as well as the group ID of AED 140 directly or via an interface function such as network exposure function (NEF) of 5G network. Next, AS 110, such as the application function (AF) in 5G network, can use this received information to update the map. This received information can include the AED ID, the AED location information and radio configuration parameters. Next, AS 110 can send a response message to confirm receipt of the information to AED manager 270 directly or via an interface function such as NEF in 5G network. AED manager 270 can also send a response message to AED radio manager 220 to confirm that AED manager 270 received the message. This response can be transmitted via the AN-CN interface function such as AMF in 5G network. When AED 140 transmits a signal, such as a backscattered radar signal that resembles the received radar signal, AED 140 can include one or more of the information including AED ID, AED absolute location, AED relative location in a map, AED application ID, other road condition messages and environment information, or any other information the AED is configured to transmit. CAV 150 can use the AED application ID to identify AED 140 on the map.

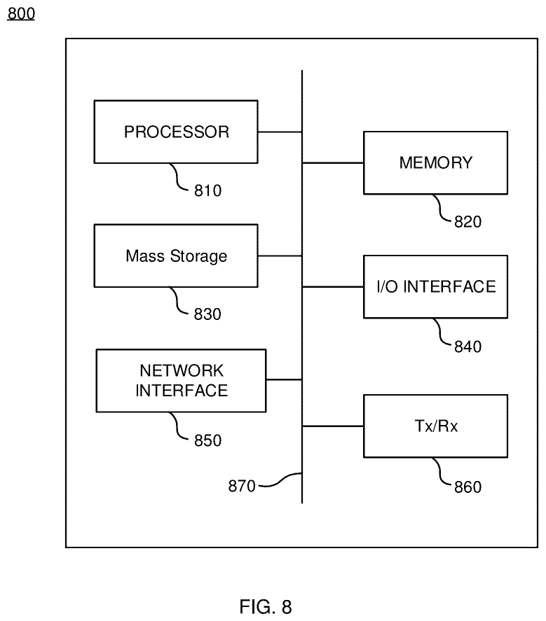

FIG. 8 is a schematic diagram of an electronic device 800 that may perform any or all of operations of the above methods and features explicitly or implicitly described herein, according to different embodiments of the present invention. For example, a computer equipped with network function may be configured as electronic device 800.

As shown, the device includes a processor 810, such as a Central Processing Unit (CPU) or specialized processors such as a Graphics Processing Unit (GPU) or other such processor unit, memory 820, non-transitory mass storage 830, I/O interface 840, network interface 850, and a transceiver 860, all of which are communicatively coupled via bi-directional bus 870. According to certain embodiments, any or all of the depicted elements may be utilized, or only a subset of the elements. Further, the device 800 may contain multiple instances of certain elements, such as multiple processors, memories, or transceivers. Also, elements of the hardware device may be directly coupled to other elements without the bi-directional bus. Additionally or alternatively to a processor and memory, other electronics, such as integrated circuits, may be employed for performing the required logical operations.

Memory 820 may include any type of non-transitory memory such as static random access memory (SRAM), dynamic random access memory (DRAM), synchronous DRAM (SDRAM), read-only memory (ROM), any combination of such, or the like. The mass storage element 830 may include any type of non-transitory storage device, such as a solid state drive, hard disk drive, a magnetic disk drive, an optical disk drive, USB drive, or any computer program product configured to store data and machine executable program code. According to certain embodiments, memory 820 or mass storage 830 may have recorded thereon statements and instructions executable by the processor 810 for performing any of the aforementioned method operations described above.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Acts associated with the method described herein can be implemented as coded instructions in plural computer program products. For example, a first portion of the method may be performed using one computing device, and a second portion of the method may be performed using another computing device, server, or the like. In this case, each computer program product is a computer-readable medium upon which software code is recorded to execute appropriate portions of the method when a computer program product is loaded into memory and executed on the microprocessor of a computing device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present disclosure may be implemented using hardware only or using software and a necessary universal hardware platform. Based on such understandings, the technical solution of the present disclosure may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present disclosure. For example, such an execution may correspond to a simulation of the logical operations as described herein. The software product may additionally or alternatively include a number of instructions that enable a computer device to execute operations for configuring or programming a digital logic apparatus in accordance with embodiments of the present disclosure.

Although the present disclosure has been described with reference to specific features and embodiments thereof, it is evident that various modifications and combinations can be made thereto without departing from the disclosure. The specification and drawings are, accordingly, to be regarded simply as an illustration of the disclosure as defined by the appended claims, and are contemplated to cover any and all modifications, variations, combinations or equivalents that fall within the scope of the present disclosure.

What is claimed is:

1. A method for determining a location, the method comprising:
broadcasting a signal;
receiving a modulated signal, corresponding to the broadcasted signal, transmitted by an electronic device;
extracting location information from the received modulated signal using an identifier of the electronic device; and
determining a location in accordance with the extracted location information.

2. The method of claim 1, wherein the method is carried out by a user device, and wherein the determined location is a location of the user device.

3. The method of claim 1, wherein broadcasting the signal comprises transmitting the signal as a Radio Detection and Ranging (RADAR) signal.

4. The method of claim 1, wherein determining the location comprises determining the location in accordance with both the extracted location information and at least one of an angle of departure associated with the received signal, an angle of arrival associated with the received signal, or an estimated distance to the electronic device.

5. The method of claim 4, wherein the estimated distance to the electronic device is determined in accordance with a plurality of received modulated signals, each of the plurality of received modulated signals transmitted by a different electronic device.

6. The method of claim 1, further comprising receiving a second modulated signal corresponding to the transmitted signal, and determining a location in accordance with information extracted from the received signals.

7. The method of claim 1, further comprising extracting supplemental information from the received modulated signal using the identifier of the electronic device, the supplemental information comprising at least one of weather information, traffic information, or road condition information.

8. The method of claim 1, further comprising determining the location by identifying a radio resource used by the electronic device.

9. The method of claim 1, wherein the modulated signal is received in a defined time slot and in a frequency band different than a frequency band used to transmit the broadcasted signal.

10. The method of claim 9, wherein the defined time slot is assigned to the electronic device and assigned time slot is used to identify the electronic device.

11. A method for providing location information for execution by an electronic device (ED), the method comprising:
receiving a signal;
modulating location information on to a signal corresponding to the received signal using the received signal, to obtain a modulated signal corresponding to the received signal; and
transmitting the modulated signal corresponding to the received signal.

12. The method of claim 11, wherein the information includes supplemental information received from a mobile network.

13. The method of claim 11, wherein the modulated signal corresponding to the received signal is transmitted in an assigned radio resource.

14. The method of claim 11, wherein the received signal powers the ED.

15. The method of claim 11, wherein the location information comprises information identifying the ED location.

16. The method of claim 11, wherein the information identifying the ED identifies a location associated with the ED.

17. A method for providing location information for execution by an electronic device (ED), the method comprising:
receiving a first signal;
generating a second signal including location information based on the first signal; and
transmitting the second signal.

18. The method of claim 17, wherein the information includes supplemental information received from a mobile network.

19. The method of claim 17, wherein the second signal is transmitted in an assigned radio resource.

20. The method of claim 17, wherein the information comprises information identifying the ED location information.
